(19) United States
(12) Patent Application Publication
(10) Pub. No.: US 2010/0169479 A1
(43) Pub. Date: Jul. 1, 2010

(54) Apparatus and method for extracting user information using client-based script

(75) Inventors: Chi Yoon JEONG, Daejeon (KR); Beom-Hwan CHANG, Daejeon (KR); Seon-Gyoung SOHN, Daejeon (KR); Geon Lyang KIM, Daejeon (KR); Jong Ho RYU, Cheonan-si, Chungnam (KR); Jong Hyun KIM, Daejeon (KR); Jung-Chan NA, Daejeon (KR); Hyun Sook CHO, Daejeon (KR); Chae Kyu KIM, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/603,010

(22) Filed: Oct. 21, 2009

(30) Foreign Application Priority Data
Dec. 26, 2008 (KR) 10-2008-0134655
Apr. 14, 2009 (KR) 10-2009-0032429

(51) Int. Cl. G06F 15/16

(52) U.S. Cl. 709/224

(57) ABSTRACT

Provided are an apparatus and method for extracting user information using a client-based script in which user information including the internet protocol (IP) addresses of an attacking host and an anonymous proxy server used by the attacking host can be collected using a client-based script that can be automatically executed in the web browser of the attacking host. According to the apparatus and the method, it is possible to detect the location of an attacking host without alerting the attacking host by using a script that can be automatically executed in a web browser of the attacking host without any program installation. In addition, according to the apparatus and the method, it is possible to collect the IP addresses of an attacking host and an anonymous proxy server, if any, used by the attacking host by directly connecting the attacking host and a monitoring server.

### CROSS-REFERENCE TO RELATED APPLICATION

This application claims priority from Korean Patent Application No. 10-2008-0134655 filed on Dec. 26, 2008 and Korean Patent Application No. 10-2009-0032429 filed on Apr. 14, 2009, in the Korean Intellectual Property Office, the disclosure of which is incorporated herein by reference in its entirety.

### BACKGROUND OF THE INVENTION

1. Field of the Invention

The present invention relates to network security technology, and more particularly, to an apparatus and method for extracting user information using a client-based script, in which the internet protocol (IP) address of an attacking host and the IP address of a proxy server, if any, used by the attacking host can be collected by transmitting a webpage to the attacking host along with a client-based script that can be automatically executed in a web browser of the attacking host, and that can set a direct connection between a monitoring server and the attacking host.

2. Description of the Related Art

As an increasing number of individuals are accessing web servers via anonymous proxy servers in order to prevent the exposure of their personal information or an increasing number of businesses or public institutions are using a number of internet protocol (IP) addresses and private networks, it has increasingly become difficult to detect the IP addresses of users who attempt to access web servers and identify attacking hosts which deliver attack against web servers.

Conventional web servers may not be able to properly collect the IP addresses of web clients especially when the web clients use proxy servers. In order to address this problem, various methods for detecting the IP address of a web client that attempts to access a web server via, for example, a proxy server, such as those using a Java applet or an ActiveX program have been suggested. However, these methods may not be effective because the execution of such programs as a Java applet and an ActiveX program can be blocked simply by web browsers' basic security functions. Alternatively, a method of detecting the IP address of a web client using a plug-in program has been suggested. This method, however, may require a plug-in program that can support two-way socket communication, and may need to involve determining whether a plug-in program properly operates in each web browser.

### SUMMARY OF THE INVENTION

The present invention provides an apparatus and method for extracting user information using a client-based script, in which the internet protocol (IP) address of an attacking host can be collected by transmitting a webpage to the attacking host together with a client-based script that can be automatically executed in a web browser of the attacking host.

The present invention also provides an apparatus and method for extracting user information using a client-based script, in which the IP addresses of an attacking host and a proxy server used by the attacking host can be collected by using a script that sets a direct connection between a monitoring server and the attacking host.

According to an aspect of the present invention, there is provided an apparatus for extracting user information using a client-based script, the apparatus including: a web server providing a client-based script, which can be automatically executed in a user's web browser and can thus collect the user's network information, when providing a webpage upon the request of the user; and a monitoring server which is connected to the user's computer when the client-based script is executed, the monitoring server collecting the user's network information and extracting and visualizing location information corresponding to the collected network information.

According to another aspect of the present invention, there is provided a method of extracting user information using a client-based script, the method including: if a request for a webpage is received from a user, transmitting the webpage and a client-based script, which can be automatically executed in the user's web browser and can thus collect the user's network information; and

allowing the client-based script to be automatically executed in the user's web browser, to generate the user's identifier, to set a socket communication between the user's computer and a monitoring server, to transmit the generated identifier to the monitoring server, and to issue a request for a webpage to the monitoring server; collecting the user's IP address during the setting of the socket communication and collecting the IP address of the proxy server during the issuing of the request for a webpage; and translating the user's IP address and the IP address of the proxy server into first location information and second location information and visualizing the first location information and the second location information.

### BRIEF DESCRIPTION OF THE DRAWINGS

The above and other features and advantages of the present invention will become more apparent by describing in detail preferred embodiments thereof with reference to the attached drawings in which:

FIG. 1A illustrates a flowchart of a method of collecting the internet protocol (IP) address of a user upon an attack delivered by an attacking host, according to an exemplary embodiment of the present invention;

FIG. 1B illustrates a flowchart of a method of collecting the IP addresses of an attacking host and an anonymous proxy server used by the attacking host upon an attack delivered by the attacking host, according to an exemplary embodiment of the present invention;

FIG. 2A illustrates a block diagram of a web server according to an exemplary embodiment of the present invention;

FIG. 2B illustrates a block diagram of a monitoring server according to an exemplary embodiment of the present invention; and

FIGS. 3A through 3C illustrate diagrams showing various examples of how to display the location of an attacking host.

### DETAILED DESCRIPTION OF THE INVENTION

The present invention will hereinafter be described in detail with reference to the accompanying drawings in which exemplary embodiments of the invention are shown.

In exemplary embodiments of the present invention, a web server may transmit a script for extracting user information to a user's computer along with a webpage requested by the user. The script may be automatically executed in the user's web browser along with the webpage, and may issue a request for the right and method to access a monitoring server to the monitoring server. If the script is allowed to access the monitoring server, the script may set a socket communication between the user's computer and the monitoring server, and may issue a request for a webpage to the monitoring server. The monitoring server may collect the internet protocol (IP) address of the user via the socket communication with the user's computer, and may collect the IP address of a proxy server used by the user via the webpage requested by the script. Thereafter, the IP addresses of the user and the proxy server may be converted into geographic information, and thus, the user's location may be visually represented based on the geographic information.

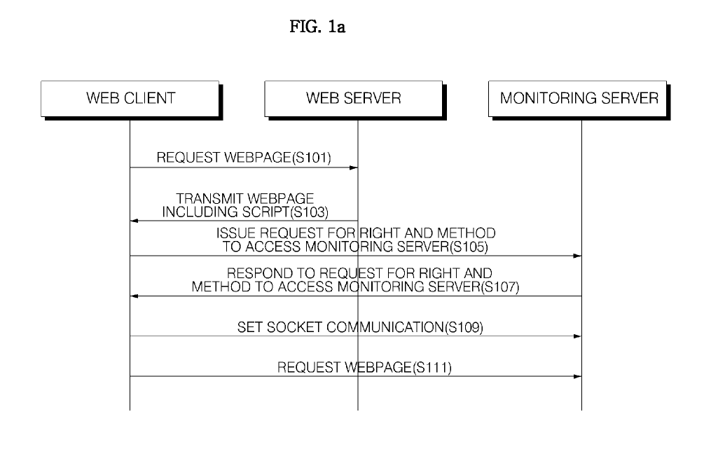

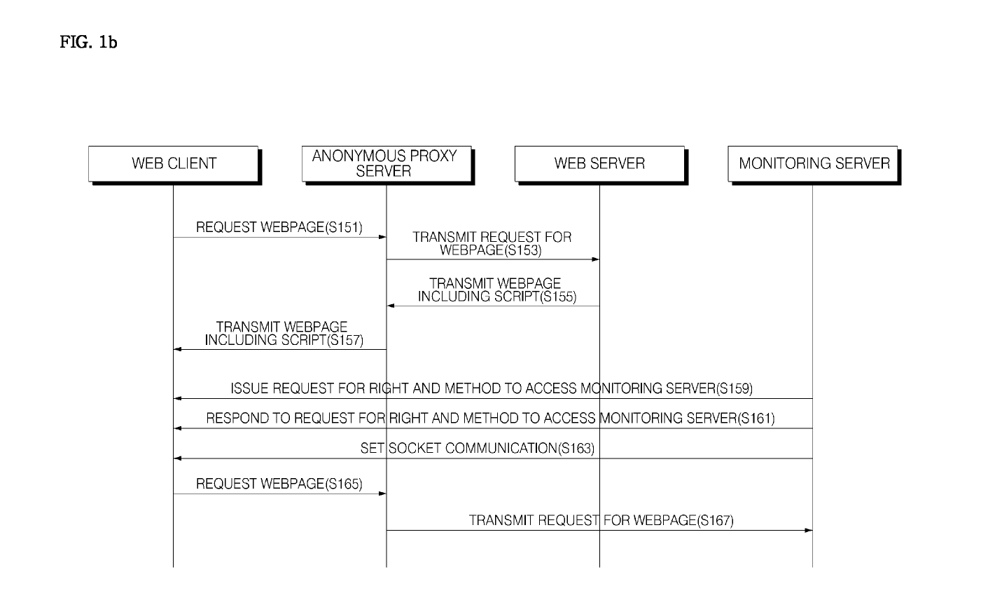

FIG. 1A illustrates a flowchart of a method of collecting the IP address of a user upon an attack delivered by an attacking host, according to an exemplary embodiment of the present invention. Referring to FIG. 1A, a web client may issue a request for a first webpage to a web server (S101). Then, the web server may transmit the first webpage to the web client along with a script for detecting the IP address of the web client (S103). The script may be automatically executed in a web browser of the web client along with the first webpage without a requirement of an additional Java applet, an ActiveX program or an ActiveX plug-in.

Once the script is executed in the web browser of the web client, a user identifier for the web client may be created by combining a time-shift value and a random value.

Thereafter, the script may issue a request for the right and method to access to a monitoring server to the monitoring server (S105).

Then, the monitoring server may respond to the request (S107), and the script may set a socket communication between the web client and the monitoring server (S109). The socket communication may be used for various purposes such as querying a database, issuing a request for transmission control protocol (TCP) communication or issuing a request for file transfer protocol (FTP) connection. The script may transmit user information, including the user identifier of the web client and information regarding a webpage having the script loaded therein, to the monitoring server.

In addition, the script may issue a request for a second webpage to the monitoring server (S111). If the web client attempts to access the web server via an anonymous proxy server, the second web page may be transmitted to the monitoring server via the anonymous proxy server, and thus, the monitoring server may be able to collect the IP address of the anonymous proxy server. Since the web client is illustrated in FIG. 1A as accessing the web server without passing through any anonymous proxy server, the IP address collected in operation S109 may be the same as the IP address collected in operation S111.

FIG. 1B illustrates a flowchart of a method of collecting the IP addresses of an attacking host and an anonymous proxy server used by the attacking host upon an attack delivered by the attacking host, according to an exemplary embodiment of the present invention. A proxy server may be defined as a network service that allows a web client to indirectly access another network service. More specifically, a function that mediates between a server and a web client may be referred to as a proxy, and a server that provides a proxy function may be referred to as a proxy server. An anonymous proxy server is an open proxy server that does not need to be authenticated in order to be used.

Proxy servers may be able to cache various services requested by web clients and thus to readily provide the cached services later upon the request of the web clients without accessing remote servers. Therefore, it is possible to reduce the time taken for a proxy server to transmit data to a web client without the need to access a remote server every time. Moreover, it is possible to reduce traffic caused by unnecessary communication and prevent a network bottleneck. However, it is generally difficult to detect attacking hosts that attack web servers via proxy servers. Thus, proxy servers are often being used for various hosts to attack web servers. Anonymous proxy servers, in particular, do not require user registration or authentication processes and are thus widely being used for remote hosts to attack networks.

It will hereinafter be described in detail how to detect an attacking host using an anonymous proxy server. In the exemplary embodiment of FIG. 1B, like in the exemplary embodiment of FIG. 1A, a web client may issue a request for a first webpage to a web server (S151). However, since, in the exemplary embodiment of FIG. 1B, unlike in the exemplary embodiment of FIG. 1A, the web client uses an anonymous proxy server, the request issued in operation S151 may be transmitted to the anonymous proxy server (S151). The anonymous proxy server may transmit the request issued by the web client to the web server (S153). Since the web server recognizes that the request transmitted by the anonymous proxy server has been issued by the anonymous proxy server, the IP address of the web client and personal information regarding the web client may not be exposed.

Thereafter, the web server may transmit a webpage obtained by merging the first webpage and a script for detecting the IP address of the web client the anonymous proxy server along with (S155). The anonymous proxy server may transmit the webpage provided by the web server to the web client (S157).

The script may be automatically executed when the first webpage is executed in a web browser of the web client. Then, the script may create a user identifier for the web client and may perform socket communication. Operations 5159, 5161 and 5163 are the same as operations S105, 107 and S109 of FIG. 1A, and thus, detailed descriptions thereof will be omitted.

Thereafter, the script may issue a request for a second webpage to the monitoring server (S165). Since, in the exemplary embodiment of FIG. 1B, unlike in the exemplary embodiment of FIG. 1A, the web client uses the anonymous proxy server, the anonymous proxy server may transmit the request issued in operation S165 to the monitoring server (S167).

In short, the exemplary embodiment of FIG. 1B is different from the exemplary embodiment of FIG. 1A in terms of how to issue a request for a webpage to the monitoring server. That is, in the exemplary embodiment of FIG. 1A, a web client may issue a request for a webpage directly to a monitoring server, and thus, the IP address collected from the socket communication between the web client and the monitoring server may be the same as the request issued by the web client. On the other hand, in the exemplary embodiment of FIG. 1B, a web client may issue a request for a webpage to a monitoring server via an anonymous proxy server, and thus, the IP address collected from the socket communication between the web client and the monitoring server may be the same as the IP address collected from the request issued by the web client. In this case, the IP address collected from the socket communication between the web client and the monitoring server may be the IP address of the web client, and the IP address collected from the request issued by the web client may be the IP address of the anonymous proxy server.

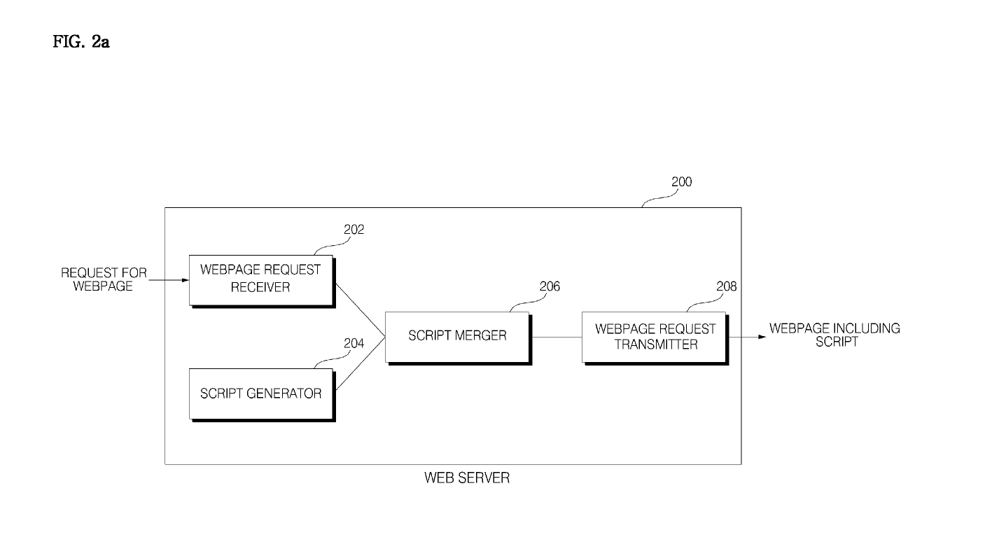

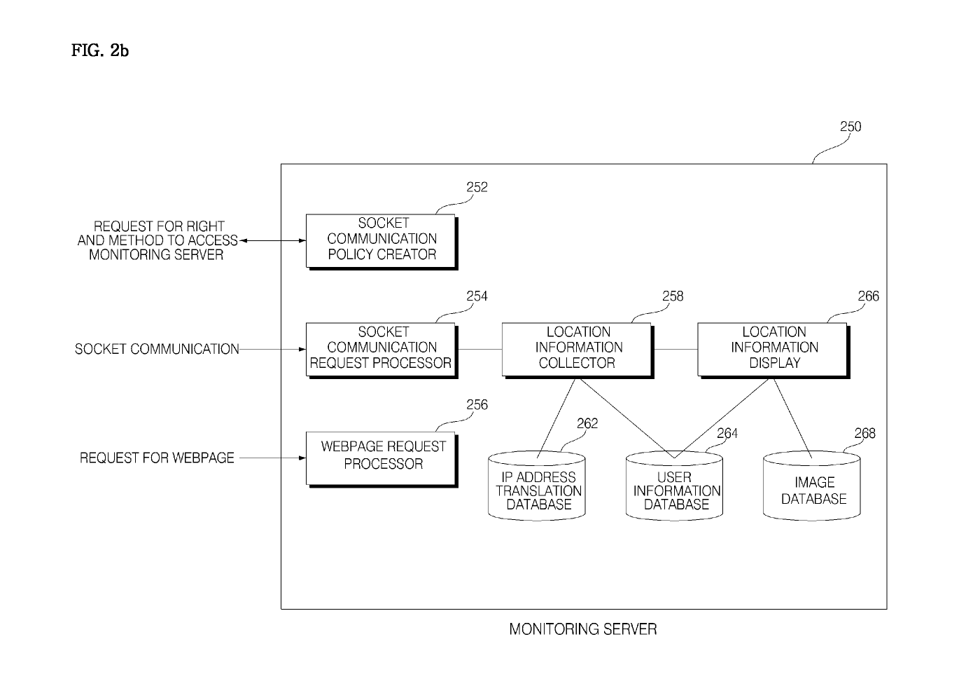

An IP address collected by the method of FIG. 1A or 1B may be visualized using geographic information, and this will be described later in detail with reference to FIG. 2B.

FIGS. 2A and 2B illustrate block diagrams of a web server 200 and a monitoring server 250, respectively, of an apparatus for extracting user information using a client-based script according to an exemplary embodiment of the present invention. Referring to FIG. 2A, the web server 200 may include a webpage request receiver 202, a script generator 204, a script merger 206, and a webpage request transmitter 208. The webpage request receiver 202 and the webpage transmitter 208 may be incorporated into a single unit. Each of the webpage request receiver 202, the script generator 204, the script merger 206, and the webpage transmitter 208 may include a network transmitter/receiver device, a processor and a memory. The webpage request receiver 202, the script generator 204, the script merger 206, and the webpage transmitter 208 may share the processors and memories with one another. The web server 200 may be implemented as a system-on-chip (SOC).

The webpage request receiver 202 may receive a webpage request signal transmitted by a user, and may transmit a webpage requested by the user to the script merger 206. The script generator 204 may generate a script for collecting the IP address of a user and may transmit the generated script to the script merger 206. Alternatively, the script generator 204 may transmit a previously-stored script to the script merger 206.

The script merger 206 may merge the webpage requested by the user and the script provided by the script generator 204 into a single webpage, and may transmit the webpage to the webpage transmitter 208. Then, the webpage transmitter 208 may transmit the webpage provided by the script merger 206 to the user.

Referring to FIG. 2B, if the script included in the webpage provided by the web server 200 is automatically executed in a web browser of the user, the monitoring server 250 may be able to acquire user information regarding the user.

The monitoring server 250 may include a socket communication policy creator 252, a socket communication request processor 254, a webpage request processor 256, a location information collector 258, a location information display 266, an IP address translation database 262, a user information database 264 and an image database 268. Each of the socket communication policy creator 252, the socket communication request processor 254, the webpage request processor 256, the location information collector 258, the location information display 266, the IP address translation database 262, the user information database 264 and the image database 268 may include a network transmitter/receiver device, a processor and a memory. The socket communication policy creator 252, the socket communication request processor 254, the webpage request processor 256, the location information collector 258, the location information display 266, the IP address translation database 262, the user information database 264 and the image database 268 may share the processors and memories with one another. The monitoring server 250 may be implemented as a system-on-chip (SOC).

The socket communication policy creator 252 may assign the right to access the monitoring server to the script by transmitting a socket policy file necessary for accessing the monitoring server. In general, an ActionScript, which is a type of client-based script, may request a socket policy file script via an 843 port. However, a socket policy file script may be transmitted via a port other than an 843 port.

The socket communication request processor 254 may collect user information such as the user identifier of a web client, information regarding a webpage having the script loaded therein, and the IP address of the web client and may transmit the collected user information. More specifically, the collected user information may be transmitted via socket communication in various manners. For example, the collected user information may be transmitted as a typical character string, may be encrypted and then transmitted, may be transmitted by being carried by a structured query language (SQL) query or may be transmitted by being carried by an FTP connection request.

The webpage request processor 256 may monitor a request, if any, issued to the monitoring server by the script for a webpage, and may collect user information such as the IP address, operating system information and browser information of a host having the script loaded therein. The script may transmit a request for a webpage by inserting a user identifier into a universal resource locator (URL) of the webpage in order for the request to be easily distinguishable.

The user information collected by the socket communication request processor 254 and the user information collected by the webpage request processor 256 may be transmitted to the location information collector 258.

The location information collector 258 may merge the user information provided by the socket communication request processor 254 and the user information provided by the webpage request processor 256 on a user-by-user basis by referencing a number of user identifiers included in the user information provided by the socket communication request processor 254 and the user information provided by the webpage request processor 256, respectively. Thereafter, the location information collector 258 may generate a number of records based on the results of the merging. The records may be stored in the user information database 264.

A collected IP address may be converted into geographic information by the IP address translation database 262, and the geographic information may be stored in the user information database 264. One or more intermediate nodes on a path to a collected IP address may be reconfigured, and the reconfigured intermediate nodes may be stored in the user information database 264.

The image database 268 may manage various images for displaying user location information present in the user information database 264. More specifically, the image database 268 may include digital map information, geographic information and satellite and/or air photos.

The location information display 266 may visualize user information based on data present in the user information database 264 and the image database 268, respectively. More specifically, the location information display 266 may display an image and may then mark the location of a user stored in the user information database 264 and the location of a proxy server used by the user on the image. The image may be a two-dimensional (2D) or three-dimensional (3D) image.

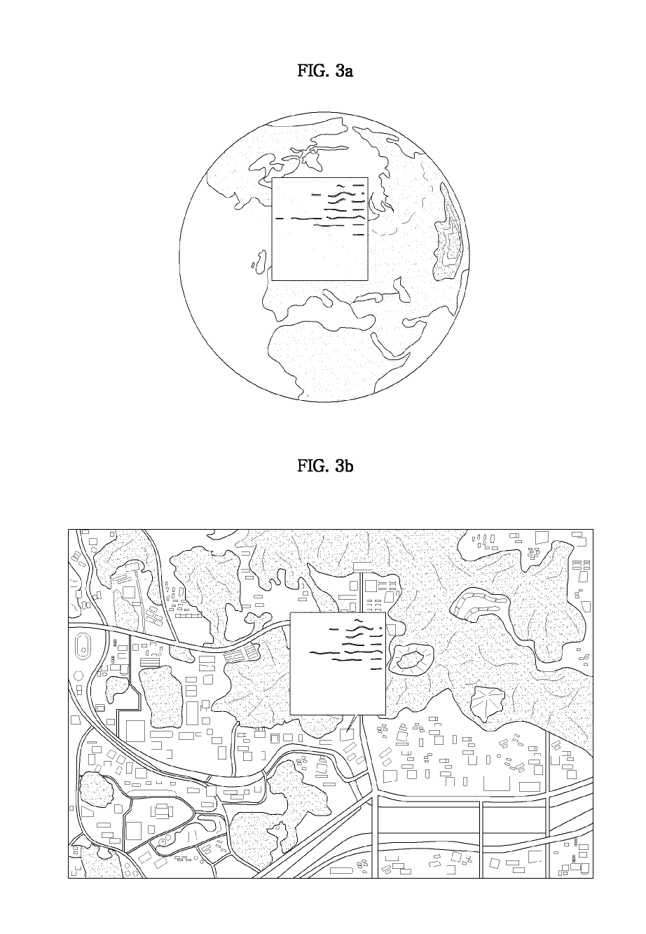

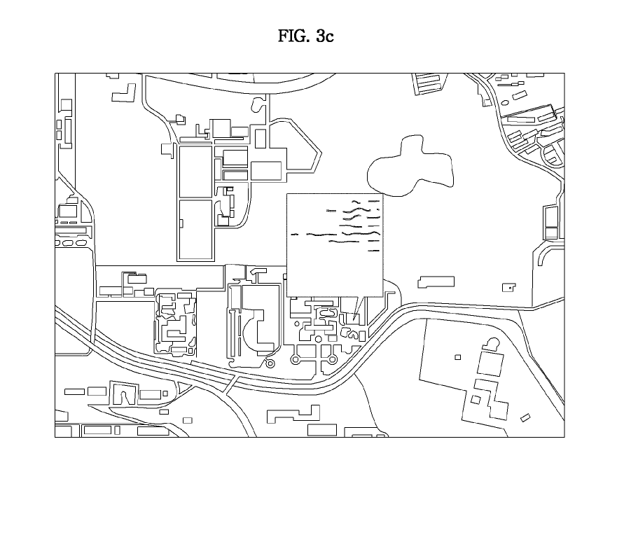

FIGS. 3A through 3C illustrate diagrams showing various examples of how to display the location of a web client. Referring to FIG. 3A, the location of a web client may be marked on a 3D satellite photo. Referring to FIG. 3B, the location of a web client may be marked on a large-scale map so that a building in which the web client resides can be effectively located. Referring to FIG. 3C, the location of a web client may be marked on a digital map that can be scaled up or down.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

As described above, according to the present invention, it is possible to detect the location of an attacking host without alerting the attacking host by using a script that can be automatically executed in a web browser of the attacking host without any program installation. In addition, it is possible to collect the IP addresses of an attacking host and an anonymous proxy server, if any, used by the attacking host by directly connecting the attacking host and a monitoring server.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for extracting user information using a client-based script, the apparatus comprising:
a web server providing a client-based script, which can be automatically executed in a user's web browser and can thus collect the user's network information, when providing a webpage upon the request of the user; and
a monitoring server which is connected to the user's computer when the client-based script is executed, the monitoring server collecting the user's network information and extracting and visualizing location information corresponding to the collected network information.

2. The apparatus of claim 1, wherein the user's network information includes the user's identifier and internet protocol (IP) address and an IP address of a proxy server, if any, used by the user.

3. The apparatus of claim 2, wherein the client-based script generates the user's identifier, sets a socket communication between the user's computer and the monitoring server, transmits the generated identifier to the monitoring server, and issues a request for a webpage to the monitoring server, and the monitoring server collects the user's IP address during the setting of the socket communication, and collects the IP address of the proxy server during the issuing of the request for a webpage.

4. The apparatus of claim 2, wherein the monitoring server includes an IP address translation database translating the user's IP address and the IP address of the proxy server into first location information and second location information and an image database storing various images for displaying the first location information and the second location information, and visualizes the first location information and the second location information by displaying one of the images present in the image database and marking the first location information and the second location information on the displayed image.

5. A method of extracting user information using a client-based script, the method comprising:
if a request for a webpage is received from a user, transmitting the webpage and a client-based script, which can be automatically executed in the user's web browser and can thus collect the user's network information; and
allowing the client-based script to be automatically executed in the user's web browser, to generate the user's identifier, to set a socket communication between the user's computer and a monitoring server, to transmit the generated identifier to the monitoring server, and to issue a request for a webpage to the monitoring server;
collecting the user's IP address during the setting of the socket communication and collecting the IP address of the proxy server during the issuing of the request for a webpage; and
translating the user's IP address and the IP address of the proxy server into first location information and second location information and visualizing the first location information and the second location information.

6. The method of claim 5, further comprising, after the transmitting of the client-based script, determining how to perform socket communication with the monitoring server and acquiring a right to access the monitoring server.

7. The method of claim 5, further comprising displaying an image selected from an image database and marking the first location information and the second location information on the displayed image.
